(19) United States
(12) Patent Application Publication
(10) Pub. No.: US 2007/0093631 A1
(43) Pub. Date: Apr. 26, 2007

(54) Thermoplastic polyurethane molding and manufacturing method thereof

(76) Inventors: Koji Nishida, Uji-shi (JP); Toshiji Kanaya, Uji-shi (JP); Takehiko Sugimoto, Nara-shi (JP); Wei Ji, Nara-shi (JP); Toshiaki Kasazaki, Nara-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/559,343

(22) PCT Filed: Apr. 19, 2004
(86) PCT No.: PCT/JP04/05577

§ 371 Date: Oct. 16, 2006

(30) Foreign Application Priority Data
Jun. 3, 2003 (JP) 2003-158604

(51) Int. Cl. C08G 18/00

(52) U.S. Cl. 528/44

(57) ABSTRACT

The thermoplastic polyurethane molding of the present invention is obtained by melting, molding, cooling and solidifying, subsequently heating to a temperature T1 (specifically, 180 to 190° C) that is not more than flow starting temperature Tm and not less than glass transition point Tg and cooling down quickly to a temperature T2 (Tm>T1>T2>Tg, specifically, 160 to 165° C.). In dynamic viscoelasticity measurement, the difference between the temperature at which LogE′ turns 4.5 MPa and the peak temperature of tan δ is 190 to 225° C.

### TECHNICAL FIELD

The present invention relates to a thermoplastic polyurethane molding having better thermal property, and a manufacturing method thereof

### BACKGROUND ART

Thermoplastic polyurethanes are used for various industrial products such as belts, tubes, films and sheets thanks to their excellent mechanical property (strength, abrasion resistance etc.). The thermoplastic polyurethanes are manufactured, generally using polyol, diisocyanate and, as chain extender, low-molecular diol. Two segments, that is, hard segments formed from diisocyanate and low-molecular diol, and soft segments formed from polyol and diisocyanate unit provide highly strong and flexible elastomer.

However, thermoplastic polyurethanes are inferior in thermal property to other thermoplastic resins, which leads to the problem that the field of use and the application are limited. Moreover, thermoplastic polyurethanes have not been satisfactory in low-temperature characteristics for some applications.

The method to make such thermal property better is a method of aging, which means that thermoplastic polyurethanes are subjected to a predetermined thermal atmosphere for long hours after being molded. However, this aging process takes, for example, as long as 16 hours or more at 80° C. or higher, resulting in the problem of poor production efficiency.

Therefore, various attempts have been made to improve thermal property such as heat resistance by changing the molecular structure of hard segments or soft segments in thermoplastic polyurethanes (For example, Japanese Unexamined Patent Publication No. 7-113004). However, this method changes the molecular structure of thermoplastic polyurethanes itself and might lead to a negative effect on other properties. For this reason, there has been a demand for improving the thermal property of thermoplastic polyurethanes without changing its molecular structure.

The object of the present invention is to provide a thermoplastic polyurethane molding that can improve thermal property very efficiently without changing its molecular structure, and a manufacturing method thereof.

### DISCLOSURE OF THE INVENTION

The present inventors have been dedicated to doing research, considering that the above problem can be solved if the higher order structure or the phase structure composed of hard segments and soft segments of a thermoplastic polyurethane molding can be controlled. As a result, the present inventors have found the new fact: a molding is obtained by melting and molding thermoplastic polyurethane, followed by cooling and solidifying; the molding is heated to a temperature T1 that is not more than flow starting temperature Tm and not less than glass transition point Tg; the molding is quickly cooled down to a temperature T2 (Tm>T1>T2>Tg) and kept at the temperature T2 for a predetermined period of time. In this case, it is possible to control the higher order structure or the phase structure composed of the hard segments and the soft segments and to improve the thermal property of the above-mentioned molding efficiently in a short period of time. In the present invention, this kind of structure control has such characteristic that the difference between the temperature at which LogE′ turns 4.5 MPa and the peak temperature of tan δ in dynamic viscoelasticity measurement is 190 to 225° C.

In short, the thermoplastic polyurethane molding of the present invention is obtained by melting, molding, cooling, solidifying, then heating to a temperature T1 that is not more than flow starting temperature Tm and not less than glass transition point Tg, and then quickly cooling down to a temperature T2 (Tm>T1>T2>Tg). It has such characteristic that the difference between the temperature at which LogE′ turns 4.5 MPa and the peak temperature of tan δ in dynamic viscoelasticity measurement is 190 to 225° C. The flow starting temperature here stands for a temperature at which resin starts to flow during temperature rise.

The method of manufacturing the thermoplastic polyurethane molding of the present invention is as follows: thermoplastic polyurethane is melted and molded, followed by cooling and solidifying; and then the thermoplastic polyurethane is heated to a temperature T1 of 180 to 190° C., quickly cooled down to a temperature T2 of 160 to 165° C. and kept at the temperature T2 at least until the phase separation of thermoplastic polyurethane occurs. In this manner, the above-mentioned molding undergoes heat treatment at a specific temperature, thereby making it possible to produce a phase-separated structure of hard segments and soft segments and to obtain the thermoplastic polyurethane molding having better thermal property.

### BRIEF DESCRIPTION OF THE DRAWINGS

FIG. 1 is a graph showing the temperature control condition of the present invention.

FIG. 2 is an optical micrograph of Sample No. 12 in Example 1.

FIG. 3 is an optical micrograph of Comparative Example 1.

FIG. 4 is a graph showing the result of wide-angle X-ray diffraction (WAXD) regarding Sample No. 12 in Example 1.

FIG. 5 is a graph showing the measurement result of dynamic viscoelasticity (DMS) regarding Sample No. 12 in Example 1.

FIG. 6 is a graph showing the measurement result of dynamic viscoelasticity (DMS) regarding Comparative Example 1.

FIG. 7 is an optical micrograph of Example 2.

FIG. 8 is an optical micrograph of Comparative Example 2.

FIG. 9 is a graph showing the measurement result of dynamic viscoelasticity (DMS) regarding Example 2.

FIG. 10 is a graph showing the measurement result of dynamic viscoelasticity (DMS) regarding Comparative Example 2.

### PREFERRED EMBODIMENTS FOR PRACTICING THE INVENTION

Thermoplastic polyurethanes to be used in the present invention are the addition Polymers comprising polyol having a molecular weight of 500 to 4000, low-molecular diol having a molecular weight of not more than 500 and diisocyanate. Examples of polyol include polyetherpolyol such as polyoxyalkylene polyol (PPG), denatured Polyetherpolyol and polytetramethylene ether glycol (PTMG), Polyesterpolyol such as condensed polyesterpolyol (for example, adipate-based polyol), lactone-based polyesterpolyol and polycarbonatediol, acrylpolyol, polybutadiene-based polyol, polyolefin-based polyol, saponified EVA and flame-retardant polyol (phosphorus-containing polyol, halogen-containing polyol).

Examples of diisocyanate include not only aromatic diisocyanate such as tolylene diisocyanate (TDI), 4,4′-diphenylmethane diisocyanate (MDI) and naphthylene diisocyanate (NDI), but also aliphatic diisocyanate such as hexamethylene diisocyanate (HDI), dicyclohexylmethane diisocyanate (HMDI) and isophorone diisocyanate (IPDI).

The low-molecular diol is used as chain extender, and 1,4-butanediol, bis(hydroxyethyl)hydroquinone and the like can be cited as examples.

In the present invention, it is preferable to use all-purpose thermoplastic polyurethanes that have been conventionally used as thermoplastic elastomer for various applications. Specific examples include thermoplastic polyurethanes that comprise hard segments formed from 4,4′-diphenylmethane diisocyanate and soft segments formed from polyol. The thermoplastic polyurethanes may have a weight-average molecular weight of 100,000 to 1,000,000 or so, and a number average molecular weight of 20,000 to 100,000 or so.

In the thermoplastic polyurethane molding of the present invention, there is a difference of 190 to 225° C. and preferably 205 to 220° C. between the temperature at which LogE′ turns 4.5 MPa and the peak temperature of tan δ in dynamic viscoelasticity measurement. The difference becomes larger than in conventional thermoplastic polyurethanes. This shows that the higher order structure or the phase structure composed of hard segments and soft segments in thermoplastic polyurethanes has changed and that phase-separated structure has occurred as specifically mentioned in Examples below. Thereby, the thermal property of the molding is improved.

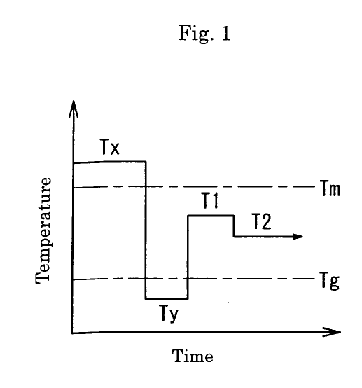

This phase-separated structure occurs as follows. As shown in FIG. 1, thermoplastic polyurethanes are melted and molded at a temperature Tx that is not less than a flow starting temperature Tm. Subsequently, the molding is cooled down to a temperature Ty, solidified, and then heated to a temperature T1 that is not more than flow starting temperature Tm and not less than glass transition point Tg. Then, the temperature is quickly dropped to a temperature T2 that is not less than glass transition point Tg, and the molding is kept at the temperature T2 until the phase-separated structure occurs. The flow starting temperature is found out by measuring a temperature at which resin starts to flow from a nozzle (normally, 1 mm in diameter×1 mm in length) while applying a constant load (normally, 10 kg) on resin with a flow tester and raising the temperature.

The temperature Tx can be a temperature that is not less than the flow starting temperature Tm and at which thermoplastic polyurethanes can be melted and molded. Normally, the temperature Tx is 200 to 240° C. Regarding a method of melting and molding, there is no specific limitation, and examples include melt extrusion molding, injection molding, calendering, and melt spinning. The shape and size of the molding is not especially limited.

The reason for cooling down from the temperature Tx to the temperature Ty is to solidify the molding. Therefore, the temperature Ty can normally be around room temperature, for example, in the range of 0 to 35° C. The cooling rate from the temperature Tx to the temperature Ty is not especially limited, and cooling at room temperature is possible. The time for keeping at the temperature Ty is not also especially limited, and may be sufficient times to solidify the molding.

The temperature T1 is in the range of 180 to 190° C. When the temperature T1 is out of this range, it may be impossible to control the higher order structure of the molding. The molding is kept at the temperature T1 for 5 to 90 seconds and preferably for 10 to 60 seconds.

The temperature T2 is in the range of 160 to 165° C. When the temperature T2 is out of this range, it may be impossible to control the higher order structure of the molding. The molding is kept at the temperature T2 at least until the phase-separated structure occurs, normally for not less than 30 seconds, preferably, for not less than one minute. The maximum time to keep the molding at the temperature T2 is not specified, but appropriately it is not more than 60 minutes.

In the present invention, it is important to quickly drop the temperature from the temperature T1 to the temperature T2. When the temperature is not lowered quickly, it may be impossible to control the higher order structure of the molding. After keeping the molding at the temperature T2 for a predetermined period of time, it can be slowly or rapidly cooled down to room temperature. It is preferable to drop the temperature from the temperature T1 to the temperature T2 at a cooling rate of about 50 to 1000° C./min.

To drop the temperature quickly from the temperature T1 to the temperature T2 as above, for example, ovens set to each temperature are prepared. The molding is heated in an oven set to the temperature T1, and then the molding is taken out from the oven, and immediately put into the other oven set to the temperature T2. Instead of the ovens, it is possible to use heaters (for example, hot plate) and touch them to the molding for heating. Alternatively, two heating furnaces set to the temperature T1 and the temperature T2 can be continuously disposed, if necessary, providing a heat rejection gap (air gap) so as to allow the molding to pass these heating furnaces in sequence.

The thermoplastic polyurethane molding of the present invention so obtained shows −20 to 10 ° C. as a peak temperature of tan δ (that is, Tg) in dynamic viscoelasticity measurement, which is lower than a conventional thermoplastic polyurethane that is heated and melted followed by cooling and solidifying. Meanwhile, the temperature at which LogE′ turns 4.5 MPa is 190 to 210° C., which is higher than a conventional thermoplastic polyurethane that is heated, melted and cooled. Consequently, as above, the difference between the temperature at which LogE′ turns 4.5 MPa and the peak temperature of tan 8 is 190 to 225° C.

The thermoplastic polyurethane molding of the present invention shows improvement in heat resistance and cold resistance and therefore can be suitably used for various applications such as constituent materials of belts, tubes, hoses and the like.

### EXAMPLES

The present invention will be described in more detail below with reference to examples. It should be noted, however, that the present invention is not limited to following examples.

### Example 1

As thermoplastic polyurethane, “Miractran E394” (flow starting temperature Tm: about 190° C., glass transition point: about 0° C.) by Nippon Polyurethane Industry Co., Ltd. was used. This polyurethane comprises MDI used for hard segments, PTMG used for soft segments and 1, 4-butanediol as chain extender.

After the thermoplastic polyurethane was placed in a mold, heated to 240° C., melted and molded, it was cooled down to around room temperature and solidified to obtain a sheet-like molding. After a while, the molding was interposed with a pair of heaters (hot plates) that were set to the temperature T1 shown in Table 1, and it was kept in this condition for 10 seconds. Subsequently, the molding was taken out, and immediately interposed with a pair of heaters (hot plates) that were set to the temperature T2 shown in Table 1. During heating process at the temperature T2, the time it took to cause phase-separated structure to occur was checked with an optical microscope (×50 times). The results were presented in Table 1.

As shown in the optical micrograph of FIG. 2, “Occurrence of phase-separated structure” here means that the structure where hard segments and soft segments are separated as phase has occurred. The time described in “Occurrence of phase-separated structure” of Table 1 represents how long the molding was kept at the temperature T2 until the phase-separated structure occurred. “No” indicates that the phase-separated structure did not occur regardless of how long the molding was kept at the temperature T2.

TABLE 1

| | Temperature | Temperature | Occurrence of phase- |
|---|---|---|---|
| Sample No. | T1 | T2 | separated structure |
| 1 | 170° C. | 155° C. | No |
| 2 | 170° C. | 160° C. | No |
| 3 | 170° C. | 165° C. | No |
| 4 | 175° C. | 155° C. | No |
| 5 | 175° C. | 160° C. | No |
| 6 | 175° C. | 165° C. | No |
| 7 | 180° C. | 155° C. | No |
| 8 | 180° C. | 160° C. | 3 minutes |
| 9 | 180° C. | 165° C. | 3 minutes |
| 10 | 180° C. | 170° C. | No |
| 11 | 185° C. | 155° C. | No |
| 12 | 185° C. | 160° C. | 1 minute |
| 13 | 185° C. | 165° C. | 3 minutes |
| 14 | 185° C. | 170° C. | No |
| 15 | 190° C. | 155° C. | No |
| 16 | 190° C. | 160° C. | 3 minutes |
| 17 | 190° C. | 165° C. | 3 minutes |
| 18 | 190° C. | 170° C. | No |

FIG. 2 is an optical micrograph of Sample No. 12 after temperature treatment. It is apparent from FIG. 2 that Sample No. 12 had a structure where hard segments and soft segments were microphase-separated.

As apparent from Table 1, when the temperature T1 was 180 to 190° C. and the temperature T2 was 160 to 165° C., microphase-separated structure occurred. When the temperature T1 was 185° C. and the temperature T2 was 160° C. (Sample No. 12), phase-separated structure occurred only in one minute particularly. The cooling rate from the temperature T1 to the temperature T2 here was measured with a thermocouple and turned out to be 61.2° C./minute.

### Comparative Example 1

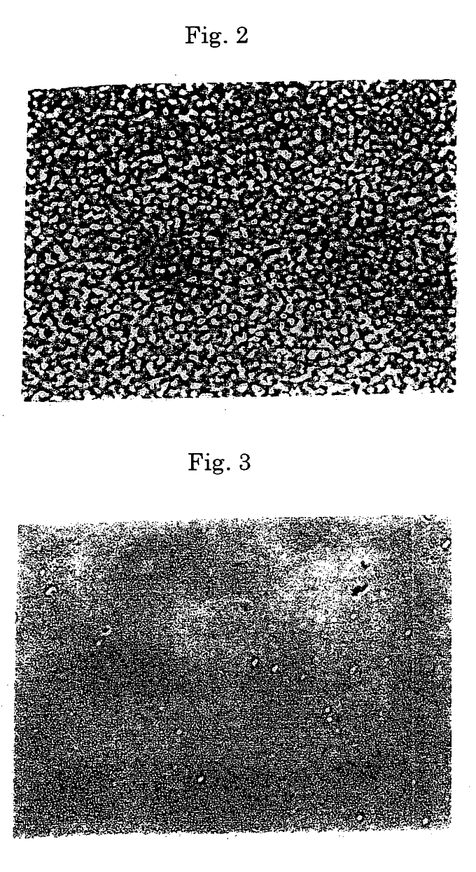

After the same “E394” used in Example 1 was melted and molded at 240° C., it was cooled down to around room temperature. Its optical micrograph is shown in FIG. 3. It is apparent from FIG. 3 that soft segments and hard segments were partially mixed without being regularized in Comparative Example 1. The samples that were considered to have no “occurrence of phase-separated structure” in Table 1 of Example had almost the same pattern as FIG. 3.

(Wide-Angle X-ray Diffraction (WAXD) Measurement)

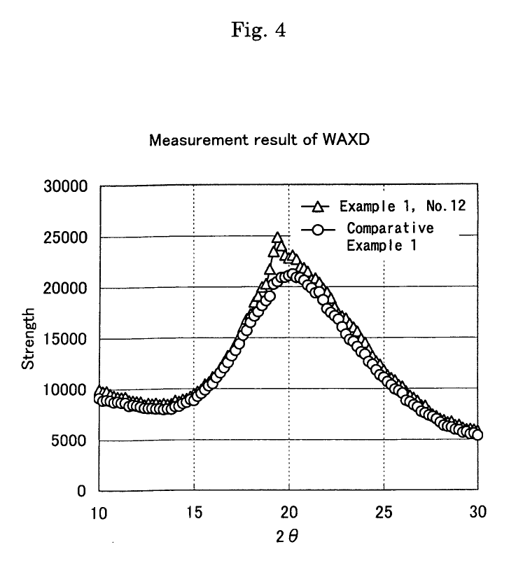

The polyurethanes obtained in Sample No. 12 in Example 1 and Comparative Example 1 underwent wide-angle X-ray diffraction measurement. Measurement was performed with “RNT-2000” made by Rigaku Corporation in the measurement range of 2θ=10° to 30° and at a measurement rate of 0.2°. The measurement results were presented in FIG. 4. It is apparent from FIG. 4 that Sample No. 12 had higher crystallinity.

(Dynamic Viscoelasticity (DMS) Measurement)

The dynamic viscoelasticity of the polyurethanes obtained in Sample No. 12 in Example 1 and Comparative Example 1 was measured. The measurement conditions were as follows.
Measuring equipment: “DMS6100” manufactured by SII (Seiko Instruments Inc.)
Temperature condition: −100° C. to +250° C.
Temperature raising rate: 5° C./minute
Measuring frequency: 1 Hz
Sample size: 5 mm in width×20 mm in length

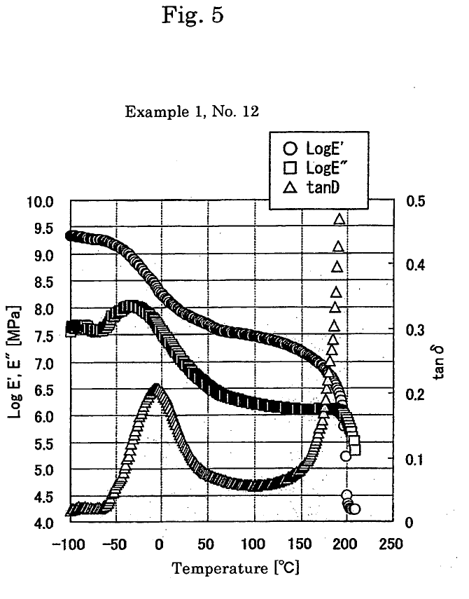

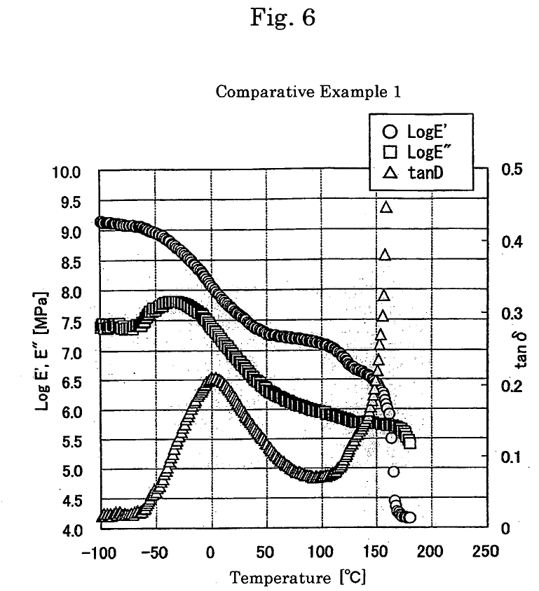

FIG. 5 and FIG. 6 respectively show the measurement results on Sample No. 12 of Example 1 and Comparative Example 1. As apparent from FIG. 5 and FIG. 6, compared to Comparative Example 1, Sample No. 12 had a rise in the dropping temperature of LogE′ and a drop in the peak temperature of tan δ. This indicates that polyurethane resin has had better heat resistance and cold resistance.

Thus, in Sample No. 12 of Example 1, the peak temperature of tan δ (that is, Tg) was dropped and the dropping temperature of LogE′ was raised. Likewise, the other samples of Example 1 wherein phase-separated structure occurred, had a drop in the peak temperature of tan 8 and a rise in the dropping temperature of LogE′. Therefore, it is clear that their difference, in other words, a value obtained by subtracting (the peak temperature of tan δ) from (the dropping temperature of LogE′) is the indicator of phase-separated structure occurring.

As for Sample No. 12 of Example 1, the peak temperature of tan δ (A), the dropping temperature of LogE′ (B), their difference (B−A) and the drop and rise values from Comparative Example 1 for the above A and B, which were obtained from the above dynamic viscoelasticity measurement, are shown in Table 2.

TABLE 2

| | | Drop from | | Rise from | |
|---|---|---|---|---|---|
| | | Comparative | | Comparative | |
| Sample | A(° C.) | Example 1 | B(° C.) | Example 1 | B − A(° C.) |
| Compar- | 4.3 | 0 | 166.2 | 0 | 161.9 |
| ative | | | | | |
| Example 1 | | | | | |
| No. 12 | −10.9 | 15.3 | 197.1 | 30.8 | 208.0 |

As apparent from Table 2, compared to Comparative Example 1, Sample No. 12 of Example 1 wherein phase-separated structure occurred, had a rise in the dropping temperature of LogE′(B), a drop in the peak temperature of tan δ (A) and an expanding difference between them (B−A).

### Example 2

As thermoplastic polyurethane, “Miractran E195” (flow starting temperature Tm: about 190° C., glass transition point: about 5° C.) by Nippon Polyurethane Industry Co., Ltd. was used. This polyurethane comprises MDI used for hard segments, adipate-based polyol used for soft segments and 1,4-butanediol as chain extender.

After the thermoplastic polyurethane was placed in a mold, heated at 240° C., melted and molded, it was cooled down to around room temperature and solidified. After a while, in a similar manner to Example 1, the molding was heated to 184° C. (temperature T1), kept at the temperature for 30 seconds and then kept at 160° C. (temperature T2) for one minute. The occurrence of phase-separated structure was observed under an optical microscope (×50 times).

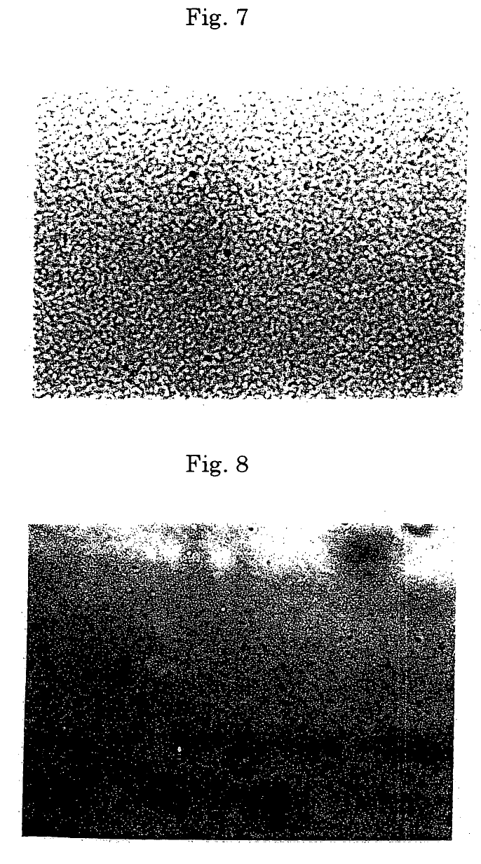

FIG. 7 is an optical micrograph of Example 2 after temperature treatment. As apparent from FIG. 7, Example 2 had a structure where hard segments and soft segments were separated as phase.

### Comparative Example 2

After the same “E195” as used in Example 2 was melted and molded at 240° C. in a mold, it was cooled down to around room temperature. FIG. 8 is an optical micrograph of this. It is apparent from FIG. 8 that hard segments and soft segments were partially mixed without being regularized in Comparative Example 2.

(Dynamic Viscoelasticity (DMS) Measurement)

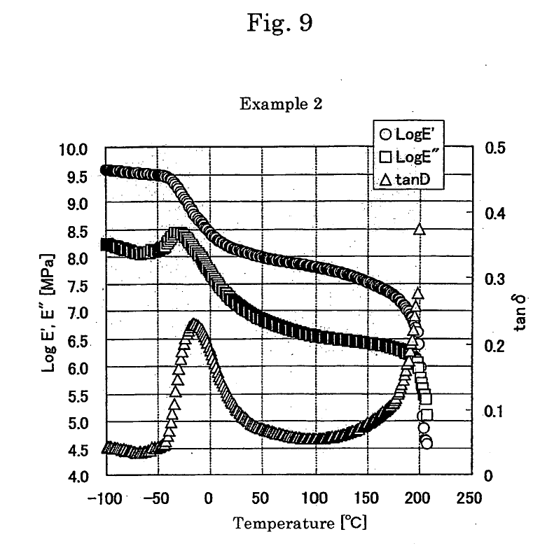

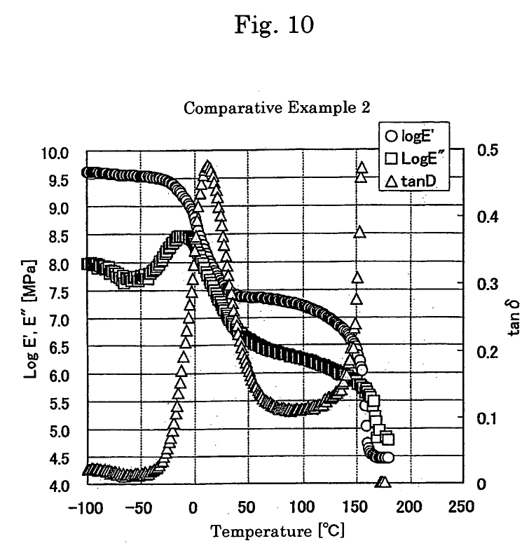

The dynamic viscoelasticity of the polyurethanes obtained in Example 2 and Comparative Example 2 was measured under the similar conditions to the above. The measurement results on Example 2 and Comparative Example 2 were separately presented in FIG. 9 and FIG. 10. As apparent from FIG. 9 and FIG. 10, compared to Comparative Example 2, Example 2 had a rise in the dropping temperature of LogE′ and a drop in the peak temperature of tan δ. The peak temperature of tan δ (A), the dropping temperature of LogE′ (B), their difference (B−A) and the drop and rise values from Comparative Example 1 for the above A and B, which were obtained from the above dynamic viscoelasticity measurement, are shown in Table 3.

TABLE 3

| | | Drop from | | Rise from | |
|---|---|---|---|---|---|
| | | Comparative | | Comparative | |
| Sample | A(° C.) | Example 1 | B(° C.) | Example 1 | B − A(° C.) |
| Compar- | 14.0 | 0 | 163.4 | 0 | 149.4 |
| ative | | | | | |
| Example 2 | | | | | |
| Example 2 | −11.8 | −25.8 | 207.8 | 44.4 | 220.0 |

Thereby, polyurethane resin has turned out to make improvement in heat resistance and cold resistance.

1. A thermoplastic polyurethane molding, which is obtained by melting and molding thermoplastic polyurethane followed by cooling and solidifying, subsequently heating to a temperature T1 that is not more than flow starting temperature Tm and not less than glass transition point Tg, and quickly cooling down to a temperature T2 (Tm>T1>T2>Tg), wherein the difference between the temperature at which LogE′ Turns 4.5 MPa and the peak temperature of tan δ in dynamic viscoelasticity measurement is 190 to 225° C.

2. The thermoplastic polyurethane molding according to claim 1, which comprises hard segments formed from 4,4′-diphenylmethane diisocyanate and soft segments formed from polyol.

3. The thermoplastic polyurethane molding according to claim 1, wherein the temperature at which LogE′ turns 4.5 MPa is 190 to 210° C. and the peak temperature of tan δ is −20 to 10° C.

4. A method for manufacturing a thermoplastic polyurethane molding, which comprises melting and molding thermoplastic polyurethane, followed by cooling and solidifying, then heating to a temperature T1 of 180 to 190° C., cooling down quickly to a temperature T2 of 160 to 165° C., and keeping at the temperature T2 at least until the phase separation of thermoplastic polyurethane occurs.
